(19) United States
(12) Patent Application Publication
(10) Pub. No.: US 2026/0122485 A1
(43) Pub. Date: Apr. 30, 2026

(54) METHODS AND SYSTEMS FOR AUTHENTICATION OVER A DATA CHANNEL

(71) Applicant: T-Mobile Innovations LLC, Overland Park, KS (US)

(72) Inventor: Hang Hoi YAU, Sammamish, WA (US)

(21) Appl. No.: 18/929,758

(22) Filed: Oct. 29, 2024

(51) Int. Cl. H04W 12/06; H04L 9/40; H04L 65/1016; H04L 65/1104

(52) U.S. Cl. CPC H04W 12/06; H04L 63/0892; H04L 65/1016; H04L 65/1104

(57) ABSTRACT

Systems, methods and devices are provided for receiving, by a wireless device, an authentication request via an IP multimedia subsystem data channel (IMS DC), in response to receiving the authentication request, generating, by the wireless device, an authentication response and transmitting, by the wireless device, the authentication response using the IMS DC.

### TECHNICAL BACKGROUND

During a call to a call center, often the call center will require subscribers to provide authenticating information for security reasons. This authenticating process will, in most cases, involve the subscriber verbally providing personal information to the call center, such as by providing the personal information to a representative on the other side of the call.

### Overview

Exemplary embodiments described herein include systems, methods, and processing nodes for authentication over a data channel. An exemplary method includes receiving, by a wireless device, an authentication request via an IP multimedia subsystem data channel (IMS DC), in response to receiving the authentication request, generating, by the wireless device, an authentication response and transmitting, by the wireless device, the authentication response using the IMS DC.

Further exemplary embodiments include a system for routing voice call traffic. The system includes a computing device communicatively connected to a wireless network, wherein the computing device includes at least one processor configured to receive an authentication request via an IMS DC, in response to receiving the authentication request, generate an authentication response and transmit the authentication response using the IMS DC.

In yet a further exemplary embodiment, a non-transitory computer readable medium is provided. The non-transitory computer-readable medium stores instructions, when executed by a processor, configuring the processor to receive an authentication request via an IMS DC, in response to receiving the authentication request, generate an authentication response and transmit the authentication response using the IMS DC.

### BRIEF DESCRIPTION OF THE DRAWINGS

FIG. 1 illustrates an exemplary system for transmission over data channels in accordance with disclosed embodiments.

FIG. 2 is a block diagram illustrating an exemplary system for authentication using a data channel in accordance with disclosed embodiments.

FIG. 3 illustrates a time series flow for authentication using data channel in accordance with disclosed embodiments.

FIG. 4 illustrates an exemplary method for authentication using a data channel in accordance with disclosed embodiments.

FIG. 5 illustrates an example of a processing node in accordance with aspects of this disclosure.

FIG. 6 illustrates an example of a computing device in accordance with aspects of this disclosure.

### DETAILED DESCRIPTION

When a voice over IP (VoIP) call is placed to a call center through a wireless network, a data channel may be set up with the call request transmitted. However, authentication steps performed by a call center often involve receiving information provided directly by the subscriber or utilizing third party software that may require additional steps for authentication, such as requiring the subscriber to have the authentication software installed on their device.

A wireless device stores authentication data as a result of its authentication with a network, such as during attachment to the network. For a wireless device that supports establishing a data channel when placing a call to a call center, this authentication data may be provided to the data channel, if authentication is requested by the call center. By the wireless device providing the authentication data, the identity of the device and subscriber calling the call center may be verified without the need for a subscriber to install additional software or expose personal information.

Exemplary embodiments described herein include methods and systems for authentication over a data channel. For example, a data channel may be established once a subscriber places a VoIP call to a call center and, using this data channel, authentication data can be transmitted by the wireless device to the call center. For example, if confirming a subscriber identity is needed, the call center may transmit an authentication request using the data channel and the wireless device may transmit the authentication data that was stored during attachment to the network.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

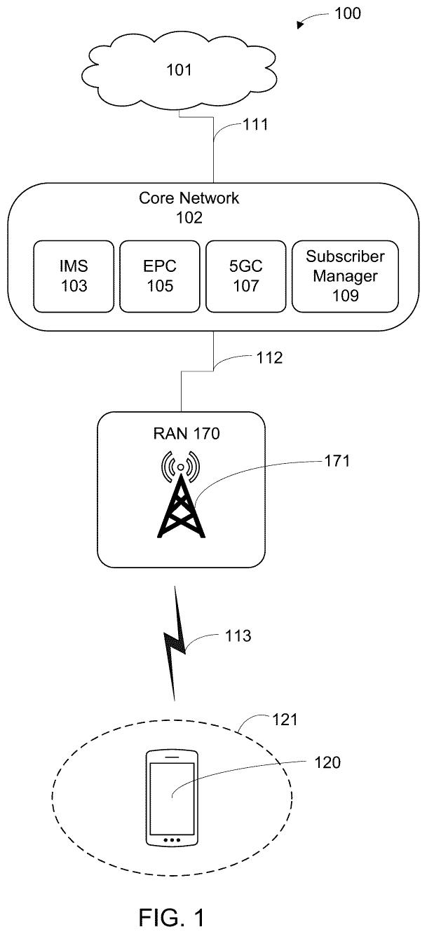

These and other examples will be described in greater detail below in relation to FIGS. 1-6.

FIG. 1 depicts an exemplary system 100 for transmission over data channels. System 100 includes a communication network 101, a core network 102 and a radio access network (RAN) 170, including at least one access node 171.

Core network 102 is connected to communication network 101 over communication link 111. Core network 102 includes an IP multimedia subsystem (IMS) 103. IMS 103 as used herein is a framework used for delivering IP multimedia services, such as voice over internet protocol (VoIP) and/or other similar services, across a network. IMS 103 may include a call session control function (CSCF). The CSCF as used herein is a component of IMS 103 used for session control, signaling and routing in multimedia communication. In embodiments, the CSCF may be used for handling session initiation protocol (SIP) communication. In embodiments, IMS 103 may be used for communication between entities or components of network 101 and wireless device 120. For example, the CSCF of the IMS 103 may be used for transmitting SIP communication to wireless device 120. IMS 103 may also include an application server (AS). For example, the AS may be used for formatting device data, such as biometric data, in a format that can be received by a receiving entity.

Core network 102 also includes an evolved packet core (EPC) 105 and a 5G core (5GC) 107. EPC 105 as used herein are core network components used for managing data for LTE, 4G, and/or other networks. In embodiments, EPC 105 may be used for establishing and managing packet data network (PDN) connections. 5GC 107 as used herein are core network components used for managing data for 5G networks. In embodiments, 5GC 107 may be used for establishing and managing packet data unit (PDU) sessions. It should be noted that core network 102 may include other components used for managing data for networks not described herein, such as a satellite core network.

Core network 102 also includes a subscriber manager 109. As used herein, a subscriber manager is a component of core network used for storing and managing subscriber data. In embodiments, subscriber manager 109 includes a home subscriber server (HSS). The HSS is a component of core network used storing subscriber data in 4G LTE networks. In embodiments, subscriber manager 109 includes a unified data management (UDM). The UDM is a component of core network 102 used for storing subscriber data in a 5G network. It should be noted that subscriber manager 109 may be configured to store and manage subscriber data for other networks not described herein, such as 6G networks.

The RAN 170 may include other devices and additional nodes not described herein. For example, RAN 170 may include devices used for routing a VoIP call from wireless device 120 to core network 102. RAN 170 is connected to core network 102 over communication link 112.

System 100 also includes a wireless device 120. In embodiments, system 100 may include multiple wireless devices. Wireless device 120 is configured to operate in one or more coverage areas 121. Wireless device 120 may be an end-user wireless device. Wireless device 120 may include any device configured to send and receive messages over SIP. Wireless device 120 may include any device configured to send and receive VoIP calls, such as voice over LTE (VoLTE) and voice over new radio (VoRN) calls. In embodiments, wireless device 120 communicates with RAN 170 over communication link 113. Examples of communication link 113 may include a 6G network link, 5G network link, 4G LTE network link, and the like.

Communication network 101 may be wired and/or wireless communication network. In embodiments, communication network 101 may include processing nodes, routers, gateways, physical and/or wireless data links for carrying data among various network elements, including combinations thereof. In embodiments, communication network 101 may include a local area network, a wide area network, an inter-network, such as the internet, and the like. Communication network 101 may be capable of carrying data, such as, for example, to support multimedia files, and data communications by wireless device 120. Wireless network protocols can include multimedia broadcast multicast service (MBMS), code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile network or wireless system (5G, 5G New Radio (“5G NR”), or 5G LTE), 6G, other terrestrial network protocols, and/or non-terrestrial network protocols. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), Asynchronous Transfer Mode (ATM), and/or other protocols. Communication network 101 may also include additional base stations, controller nodes, telephony switches, internet routers, network gateways, computer systems, communication links, or some other type of communication equipment, and combinations thereof.

The core network 102 includes core network functions and elements. The core network 102 may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QoS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 120 and is responsible for handling connection and mobility management tasks. The SMF is primarily responsible for creating, updating, and removing sessions and managing session context. The UDM function provides services to other core functions, such as the AMF, SMF, and NEF. The UDM may function as a stateful message store, holding information in local memory. The NSSF can be used by the AMF to assist with the selection of network slice instances that will serve a particular device. Further, the NEF provides a mechanism for securely exposing services and features of the core network.

Although one core network 102 is shown, multiple core networks 102 may be utilized. Alternatively, the single core network 102 may include a distributed, cloud-native, converged core gateway. For example, the converged core gateway could connect EPC 105 to 5GC 107 network.

Communication links 111 and 112 can use various communication media, such as air, space, metal, optical fiber, or some other signal propagation path, including combinations thereof. Communication links 111 and 112 can be wired or wireless and use various communication protocols such as Internet, Internet protocol (IP), local-area network (LAN), S1, optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 111 and 112 can be direct links or might include various equipment, intermediate components, systems, and networks, such as a cell site router, etc. Communication links 111 and 112 may comprise many different signals sharing the same link.

In embodiments, RAN 170 may include various access network systems and devices such as access node 171. The RAN 170 is disposed between the core network 102 and the end-user wireless devices 120. Components of the RAN 170 may communicate directly with the core network 102 and others may communicate directly with the end user wireless devices 120. The RAN 170 may provide services from the core networks 102 to the end-user wireless devices 120.

The RAN 170 includes at least an access node (or base station) 171 such as an eNodeB or gNodeB communicating with the plurality of end-user wireless devices 120. In embodiments, access node 171 includes a unique identifier. It is understood that the disclosed technology may also be applied to communication between an end-user wireless device and other network resources, such as relay nodes, controller nodes, antennas, etc. Further, multiple access nodes may be utilized. For example, some wireless devices may communicate with an LTE eNodeB and others may communicate with an NR gNodeB.

Access node 171 can be, for example, standard access nodes such as a macro-cell access node, a base transceiver station, a radio base station, an eNodeB device, an enhanced eNodeB device, a gNodeB in 5G NR, or the like. The gNBs may include, for example, centralized units (CUs) and distributed units (DUs).

In additional embodiments, access nodes may comprise two co-located cells, or antenna/transceiver combinations that are mounted on the same structure. Alternatively, access node 171 may comprise a short range, low power, small-cell access node such as a microcell access node, a picocell access node, a femtocell access node, or a home eNodeB device. As will be further described below, functionality for authentication over a data channel may be included within the access nodes. Access node 171 can be configured to deploy one or more different carriers, utilizing one or more RATs. For example, a gNodeB may support NR and an eNodeB may provide LTE coverage. It would be evident to one of ordinary skill in the art, in light of this disclosure, the many other combinations of access nodes and carriers that could be deployed.

The access nodes 171 may include a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless devices 120 may include any wireless device included in a wireless network. For example, the term “wireless device” may include a relay node, which may communicate with an access node. The term “wireless device” may also include an end-user wireless device, which may communicate with the access node 171 through the relay node. The term “wireless device” may further include an end-user wireless device that communicates with the access node 171 directly without being relayed by a relay node.

Wireless devices 120 may be any device, system, combination of devices, or other such communication platform capable of communicating wirelessly with access network 171 using one or more frequency bands and wireless carriers deployed therefrom. Each of wireless devices 120, may be, for example, a mobile phone, a wireless phone, a wireless modem, a personal digital assistant (PDA), a VoIP phone, a voice over packet (VOP) phone, or a soft phone, an internet of things (IoT) device, as well as other types of devices or systems that can send and receive audio or data. The wireless devices 120 may be or include high power wireless devices or standard power wireless devices. Other types of communication platforms are possible.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork, such as the internet. System 100 may be capable of communicating signals and carrying data, for example, to support voice, push-to-talk, broadcast video, and data communications by end-user wireless devices 120. System 100 may include additional base stations, controller nodes, telephony switches, internet routers, network gateways, computer systems, communication links, or other type of communication equipment, and combinations thereof.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the RAN 170 and the core network 102.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for routing voice call transmission may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

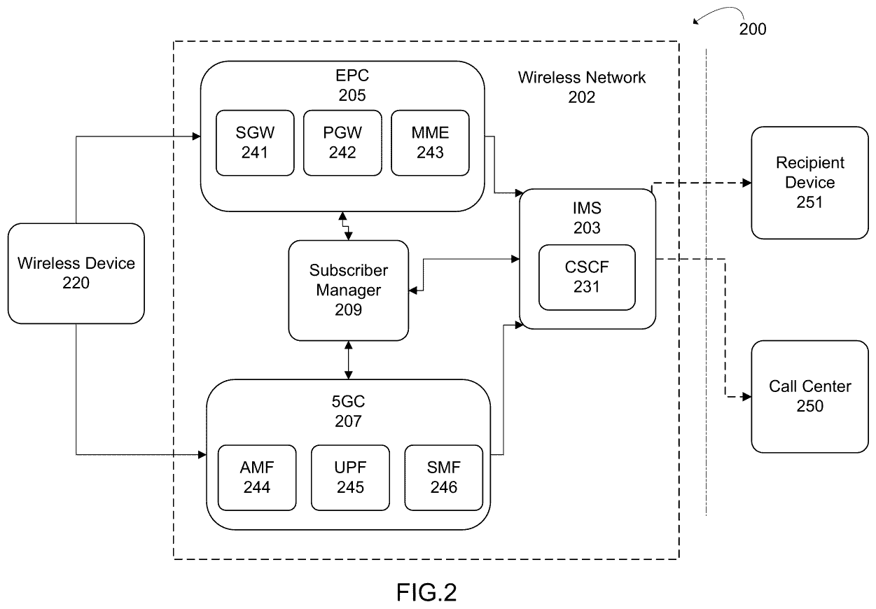

Now referring to FIG. 2, an exemplary system 200 for authentication using data channel is presented. System 200 includes a wireless device 220. Wireless device 220 may be the same as wireless device 120. System 200 also includes a wireless network 202. Wireless network 202 may include a RAN, core network and/or a communication network, which may be the same as, respectively, RAN 170, core network 102 and communication network 101. Wireless network 202 includes services and components used by a wireless network for handling voice and data transmissions. Wireless network 202 includes IMS 203, EPC 205 and 5GC 207. IMS 203, EPC 205 and 5GC 207 may be the same as IMS 103, EPC 105 and 5GC 107, respectively.

Wireless network 202 also includes a subscriber manager 209. Subscriber manager, as used herein, is a component of wireless network 202 used for storing and managing subscriber and wireless device 220 information. Subscriber manager 209 includes data used for authentication and enabling attachment of wireless device 220 to wireless network 202. In embodiments, subscriber manager 209 may be, or include, a home subscriber server (HSS). In embodiments, subscriber manager 209 may be, or include, a unified data manager (UDM). In some embodiments, subscriber manager 209 may include an authentication, authorization and accounting (AAA) server. Subscriber manager 209 may include other components not described herein, such as an authentication server function (AUSF). Subscriber manager 209 may be the same as subscriber manager 109.

System 200 also includes a call center 250. As used herein, call center 250 is a part of a telecommunication system (e.g., wireless network 202), or part of an entity equipped with computing devices implementing the telecommunication system, that is capable of transmitting and receiving IMS traffic. One or more computing devices supporting the call center 250 may use session initiation protocol (SIP) trunking to connect to IMS 203, which allows call center 250 to send and receive voice and multimedia data over an IP network, as well as perform other communication tasks. Such computing devices supporting the call center 250 may use SIP and session description protocol (SDP) for managing session and session parameters. In embodiments, call center 250 may include a private branch exchange (PBX). As used herein, a PBX is a telecommunication system that integrates IP based networks to manage voice, video and data communications within an organization.

System 200 also includes a recipient component 251. As used herein, a recipient component 251 may include any computing device or component that is capable of receiving IMS traffic, such as signaling and voice transmission. In embodiments, recipient component 251 may be similar to wireless device 220. For example, both wireless device 220 and recipient component 251 may be smartphones.

Wireless network 202 connects to call center 250 or recipient device 251 through a communication link. The communication link may include communication link 111 described in reference to FIG. 1.

In embodiments, IMS 203 includes a call session control function (CSCF) 231. CSCF 231 as used herein is a component of IMS 203 used for session control, signaling and routing in multimedia communication. In embodiments, CSCF 231 is used for handling SIP communication. For example, CSCF 231 may handle establishing a default bearer session with wireless device 220 through EPC 205 or 5GC 207 once wireless device 220 connects to wireless network 202. In embodiments, CSCF 231 is used for establishing a dedicated bearer for the IMS DC. For example, CSCF 231 may be used for establishing a dedicated session for the IMS DC upon receiving an SIP UPDATE from wireless device 220.

In embodiments, EPC 205 includes serving gateway (SGW) 241, packet data network gateway (PGW) 242 and mobility management entity (MME) 243. EPC 205 may include other components not described herein.

In embodiments, 5GC 207 includes access and mobility management function (AMF) 244, user plane function (UPF) 245 and session management function (SMF) 246. 5GC may include other components not described herein, such as policy control function (PCF) for managing policy related decisions.

In an example, wireless device 220 transmits a request to attach to wireless network 202.

In an example where the wireless device 220 attempts to attach to a 4G LTE network, MME 243 receives the attach request. Based on the request, MME 243 authenticates the wireless device 220 using subscriber manager 209. In this example, subscriber manager 209 may be a HSS or AAA server. For example, subscriber manager 209 may use the international mobile subscriber identity (IMSI) and secrets stored in the universal subscriber identity module (USIM) of the wireless device 220 and subscriber manager 209 to verify the identity of the device.

For an example where the wireless device 220 attempts to attach to a 5G network, AMF 244 receives the attach request. Based on the request, AMF 244 authenticates the wireless device 220 using subscriber manager 209. In this example, subscriber manager 209 may be a UDM coupled with an AUSF. UDM may use AUSF to transmit an authentication response to AMF 244.

MME 243 establishes a default bearer, or SMF 246 establishes a default PDN session, once the wireless device is authenticated. IMS 203 authenticates the wireless device 220 for IMS services using the CSCF using the default bearer. The “defaults PDN session” will hereon be referred as default bearer for ease of description.

The wireless device 220 is configured to store authentication data after successful authentication with wireless network 202. As used herein, authentication data may include any data used by wireless network 202 for confirming that wireless device 220 has been successfully authenticated. Authentication data may include authentication tokens, bearer ID, dedicated bearer parameters, IMS registration status, IMS security keys, and the like. In embodiments, authentication data may include security keys used in the process of encrypting communication between the wireless device 220 and call center 250, or recipient device 251. For example, the authentication data may include a key for access security management entity (K_ASME) generated from an authentication and key agreement (AKA) procedure.

Once wireless device 220 is attached and the default bearer is established, wireless device 220 may be configured to transmit a VoIP call request to call center 250, or recipient device 251. Recipient device 251 may be standalone or may be a part of call center 250. In embodiments, CSCF 231 transmits an SIP INVITE from the wireless device 220 to the call center 250 or recipient device 251. In embodiments, the SIP INVITE may include session description protocol (SDP) parameters that establishes an IMS DC for the session.

The wireless device 220, after transmitting the call request to call center 250 or recipient device 251, is configured to generate an authentication response based on receiving an authentication request. The authentication request may be received using the default bearer using SIP. In embodiments, the authentication request may be received by a SIP INFO request. For example, call center 250 may transmit a SIP INFO that includes an authentication request transmitted over an IMS DC established when the call request is transmitted.

As described above, wireless device 220 is configured to generate the authentication response based on receiving the request. The authentication response is generated using the authentication data stored based on the successful authentication with wireless network 202. In embodiments, wireless device 220 may be further configured to generate the authentication response using biometric data (e.g., fingerprint data, facial image data, retinal image data, etc.) stored or inputted at the wireless device 220. For example, the wireless device 220 may transmit the authentication response that includes data authenticating the wireless device 220, such as the data generated after attachment to wireless network 202, and data authenticate the identity of the subscriber using the device, such as biometric data used for unlocking the device.

The authentication response is transmitted using an IMS DC. In an embodiment, the authentication response and establishment of the IMS DC may be performed with a SIP UPDATE transmitted by wireless device 220. For example, wireless device 220 may transmit a SIP UPDATE that includes a session description protocol (SDP) with parameters establishing the IMS DC and subsequently transmitting the authentication response using the IMS DC. In embodiments, the authentication response may be transmitted using an IMS DC already established. For example, an IMS DC is established when a VoIP is made. In embodiments, the SIP UPDATE may also include parameters for establishing a dedicated bearer. In an example where the IMS DC is established using the SIP UPDATE, the wireless device 220 may be configured to transmit an authentication response based on a signal, or parameter, transmitted using SIP INFO.

In some embodiments, 5GC 207 may be configured to implement an evolved packet system (EPS) fallback. As used herein, EPS fallback is a feature of wireless network 202 that switches between utilizing 5GC 207 to utilizing EPC 205 components without terminating the established sessions. For example, if connectivity between the wireless device 220 and the PBX 250 using a 5G system (5GS), which includes 5GC 207 and other components of wireless network 202 such as gNodeBs, becomes unreliable, AMF 244 transmits a signal to wireless device 220 to switch connection to EPS, which includes EPC 205 and its related nodes, such as eNodeB. Once the wireless device 220 switches to EPS, MME 243 receives context for the ongoing sessions from AMF 244, such as session used by IMS DC. It should be noted that other components may be involved in the EPS fallback process. For example, UPF 245 may also transfer user plane context to EPC 205, where SGW 241 and PGW 242 may ensure that default bearer, such as for signaling session, is maintained and/or may have ensure EPC 205 has proper context to establish a dedicated bearer.

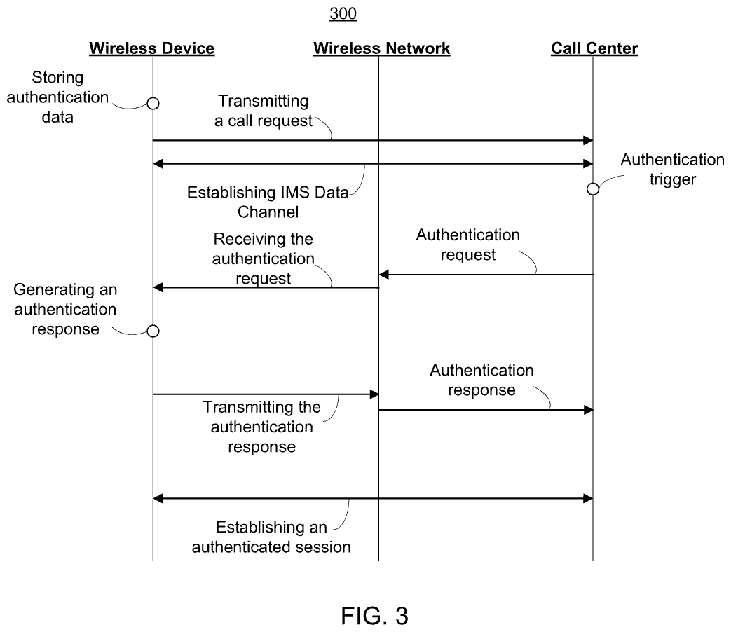

Now referring to FIG. 3, a time series flow 300 is presented. The time series flow begins with a wireless device transmitting a call request. However, prior to the transmission, the wireless device performs the step of storing authentication data. The authentication data includes data indicating that the wireless device is authenticated by the wireless network. For example, the authentication data may include data generated after a successful AAA request sent by the wireless device to the wireless network.

As the flow starts by transmitting a call request, in this time series flow the call request is transmitted to a call center. The call request may be for a VoLTE or a VoRN call. As noted above, VoLTE and VORN are used as examples for ease of description. As such other data telecommunication technologies may be used which are not described herein. It should be noted that the call center is only one example of component or entity that may receive the call request. As noted in reference to FIG. 2, SIP signaling is performed when the call request is started. For example, the call request may be an SIP INVITE. The call center and recipient device may include the call center 250 and recipient device 251 described in reference to FIG. 2. For example, the communication and data processing tasks described herein with respect to the call center 250 may be performed by and/or in conjunction with one or more computing devices supporting the call center 250.

The flow continues by establishing an IMS DC. For example, the IMS DC may be established using SDP parameters transmitted as part of the SIP INVITE.

It should be noted that although the step of establishing the IMS DC is described as occurring after transmitting the call request, establishing the IMS DC and transmitting the call request may occur with the same transmission. For example, the transmission including an SIP INVITE would transmit the SIP signaling and SDP parameters for establishing the IMS DC.

Once the call request is started, the flow is dependent on an authentication trigger to occur at the receiving end of the call request, in this flow the call center. The authentication trigger may be a request by a call center representative to verify the identity of the caller. For example, the call center representative may input the request into the one or more computing devices supporting the call center. Once this authentication trigger occurs, the call center generates an authentication request, which is forwarded by the wireless network to the wireless device using the IMS DC. The flow proceeds by the wireless device receiving the authentication request. The authentication request may be transmitted by an SIP INFO request, using the IMS DC. As noted in reference to FIG. 2, the SIP INFO request does not modify the established session.

Based on receiving the authentication request, the flow continues by generating an authentication response by the wireless device. The authentication response may be sent using a SIP UPDATE modifying the established session. In some embodiments, the IMS of the wireless network may establish a session with a dedicated bearer for the IMS DC.

The flow continues by transmitting the authentication response to the call center using the IMS DC, which includes the wireless network receiving and forwarding the authentication response to the call center.

Once the call center receives the authentication response and the wireless device is authenticated and authorized, by the call center, the flow ends by establishing an authenticated session between the wireless device and the call center. In embodiments, the authenticated session may be encrypted. As noted above, the call center is one example of entities, or components, that could be included.

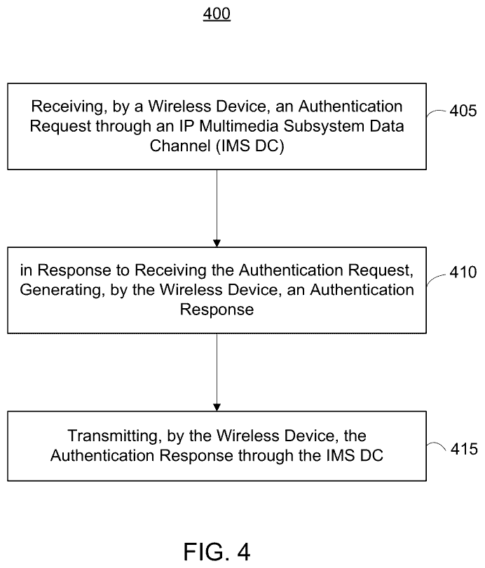

Now referring to FIG. 4, a flow diagram of method 400 for authentication over a data channel is presented. Method 400 includes, at step 405, receiving, by a wireless device, an authentication request via an IMS DC. In embodiments, the authentication request is an AAA request. In embodiments, receiving the authentication request includes using SIP. In further embodiments, the authentication request may be in SIP INFO format. The wireless device may include wireless device 120 and 220, described in reference to FIGS. 1 and 2 respectively.

At step 410, method 400 includes, in response to receiving the authentication request, generating, by the wireless device, an authentication response. In embodiments, the authentication response may include biometric data. For example, the authentication response may include data generated at the attachment by the wireless device to a network and biometric data stored at the wireless device. In this example, both the wireless device and the identity of a subscribing using the wireless device may be authenticated.

The method 400, at step 415, includes transmitting, by the wireless device, the authentication response using the IMS DC. In embodiments, method 400 may include establishing the IMS DC.

In embodiments, method 400 may include establishing an authenticated session based on the authentication response. In embodiments, transmitting the authentication response may include using SIP. In further embodiments, the authentication response may be in a SIP UPDATE format.

In embodiments, method 400 may include establishing a call between the wireless device and a recipient device, and subsequently transmitting, by the wireless device, the authentication response using the IMS DC to the recipient device after call has been established. The recipient device may include recipient device 251 described in reference to FIG. 2.

In embodiments, method 400 may include transmitting the authentication response to a call center. The call center may include call center 250 described in reference to FIG. 2.

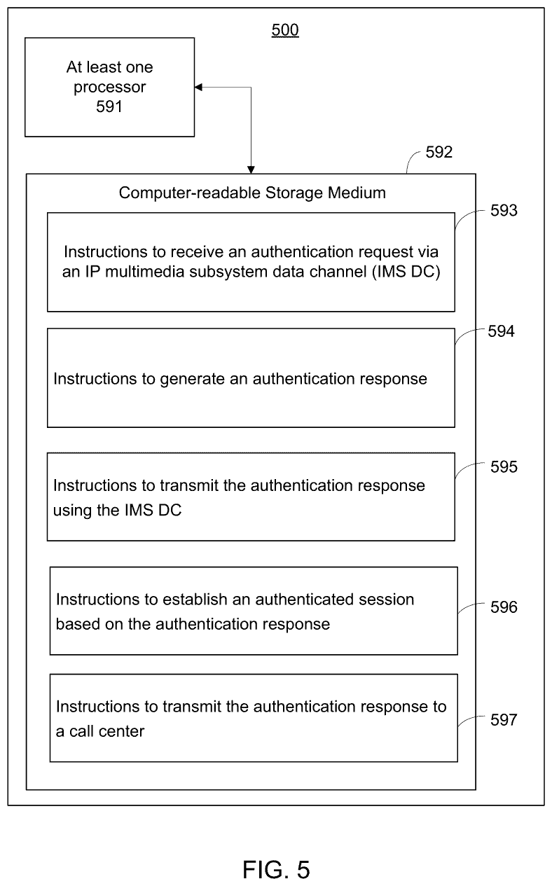

Now referring to FIG. 5, an example computing device 500 is presented. In embodiments, computing device 500 may include a wireless device, such as wireless device 120 and 220 described, respectively, in reference to FIGS. 1 and 2. In this example, computing device 500 includes at least one processor 591 communicably coupled to a computer-readable storage medium 592. The at least one processor 591 may include a microprocessor, a microcontroller, one or more central processing unit (CPU) cores, an application-specific integrated circuit (ASIC), one or more graphical processing unit (GPU) cores, a field programmable gate array (FPGA), and/or any other hardware device suitable for retrieval and execution of instructions from computer-readable storage medium 592. In instances, at least one processor 591 may include electronic circuitry for performing instructions described in this disclosure.

In instances, computer-readable storage medium 592 may be any medium suitable for storing executable instructions. In examples, without limitation, computer-readable storage medium 592 may include read-only memory (ROM), random-access memory (RAM), erasable electrically programmable ROM (EEPROM), Solid State Drive (SSD), optical disc, and the like. Computer-readable medium storage 592 may be disposed within computing device 500. In embodiments, computer-readable storage medium 592 may be external, and communicably connected, to computing device 500. The instruction stored on computer-readable storage medium may be used to implement method steps described in reference to FIG. 4.

In this example, computer-readable storage medium 592 is encoded with set of instructions 593, 594 and 595. In some embodiments, computer-readable storage medium 592 may further be encoded with set of instructions 596 and 597. In embodiments, executable instructions included in each block may be included in different blocks shown and blocks not shown.

Instruction 593, when executed by at least one processor 591, configures the at least one processor 591 to receive an authentication request via an IMS DC.

Instruction 594, when executed by at least one processor 591, configures the at least one processor 591 to generate an authentication response in response to receiving the authentication request.

In some embodiments, instruction 595, when executed by at least one processor 591, configures the at least one processor 591 to transmit the authentication response using the IMS DC.

In embodiments, computer-readable storage medium 592 may include instruction 596 configuring the at least one processor 591 to establish an authenticated session based on the authentication response. In embodiments, computer-readable storage medium 592 may include instruction 597 configuring the at least one processor 591 to transmit the authentication response to a call center. The call center may include call center 250 described in reference to FIG. 2.

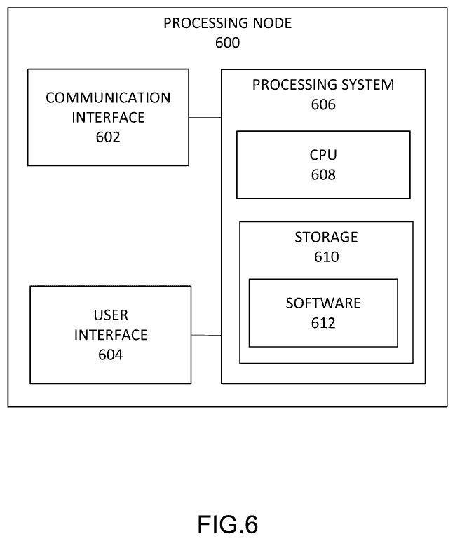

Now referring to FIG. 6, an example processing node 600, which may be configured to perform the methods and operations disclosed herein for authentication over a data channel. The processing node 600 includes a communication interface 602, user interface 604, and processing system 606 in communication with communication interface 602 and user interface 604. Communication interface 602 may include hardware components, such as network communication ports, devices, routers, wires, antenna, transceivers, etc. User interface 604 may include hardware components, such as touch screens, buttons, displays, speakers, etc.

Processing system 606 includes a central processing unit (CPU) or processor 608 and storage 610. Storage 610 may include a disk drive, flash drive, memory circuitry, or other memory device including, for example, a buffer. Storage 610 can store software 612 which is used in the operation of the processing node 600. Software 612 may include computer programs, firmware, or some other form of machine-readable instructions, including an operating system, utilities, drivers, network interfaces, applications, or some other type of software. Processing system 606 may include a processor 608 and other circuitry to retrieve and execute software 612 from storage 610, which may be internal or external to the processing system 606. Processing node 600 may further include other components such as a power management unit, a control interface unit, etc., which are omitted for clarity. Communication interface 602 permits processing node 600 to communicate with other network elements. User interface 604 permits the configuration and control of the operation of processing node 600. Processing node 600 may be included in various elements of the wireless network including an access node, proxy call session control function (P-CSCF), emergency call session control function (E-CSCF), gateway mobile location center (GMLC), secure telephone identity authentication service (STI-AS), session border controller (SBC), and the like. In this example, software 612 may include the instructions described in reference to FIG. 5.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
receiving, by a wireless device, an authentication request via an IP multimedia subsystem data channel (IMS DC);
in response to receiving the authentication request, generating, by the wireless device, an authentication response; and
transmitting, by the wireless device, the authentication response using the IMS DC.

2. The method of claim 1, further comprising:
establishing an authenticated session based on the authentication response.

3. The method of claim 1, further comprising transmitting, by the wireless device, the authentication response to a call center.

4. The method of claim 1, wherein the authentication request is an authentication, authorization and accounting (AAA) request.

5. The method of claim 1, wherein the authentication response comprises biometric data.

6. The method of claim 1, wherein receiving the authentication request and transmitting the authentication response comprises using a session initiation protocol (SIP).

7. The method of claim 6, wherein the authentication request is in an SIP INFO format.

8. The method of claim 6, wherein the authentication response is in an SIP UPDATE format.

9. The method of claim 1, further comprising establishing an IP multimedia subsystem data channel (IMS DC).

10. The method of claim 1, further comprising: establishing a call between the wireless device and a recipient device and subsequently transmitting, by the wireless device, the authentication response using the IMS DC to the recipient device after call has been established.

11. The method of claim 1, further comprising transmitting, by the wireless device, a call request.

12. The method of claim 1, further comprising receiving, by the wireless device, the authentication request based on an authentication trigger.

13. A system, the system comprising:
a computing device communicatively connected to a wireless network, wherein the computing device comprises at least one processor configured to:
receive an authentication request via an IP multimedia subsystem data channel (IMS DC);
in response to receiving the authentication request, generate an authentication response; and
transmit the authentication response using the IMS DC.

14. The system of claim 13, wherein the computing device is further configured to establish an authenticated session based on the authentication response.

15. The system of claim 13, wherein the computing device is further configured to transmit the authentication response to a call center.

16. The system of claim 13, wherein the authentication request is an authentication, authorization and accounting (AAA) request.

17. The system of claim 13, wherein the authentication response comprises biometric data.

18. The system of claim 13, wherein the computing device is further configured to receive the authentication request and transmit the authentication response using a session initiation protocol (SIP).

19. The system of claim 13, wherein the computing device is further configured to establish a call with a recipient device and subsequently transmit the authentication response using the IMS DC to the recipient device after call has been established.

20. A non-transitory computer-readable medium storing instructions, when executed by at least one processor, configuring the at least one processor to:
receive an authentication request via an IP multimedia subsystem data channel (IMS DC);
in response to receiving the authentication request, generate an authentication response; and
transmit the authentication response using the IMS DC.
